(19) United States
(12) Patent Application Publication
(10) Pub. No.: US 2004/0234941 A1
(43) Pub. Date: Nov. 25, 2004

(54) Apparatus for and methods of preparing sperm

(76) Inventor: Farhang Abed, Padaran St. (IR)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(21) Appl. No.: 10/481,548

(22) PCT Filed: Jun. 18, 2002
(86) PCT No.: PCT/GB02/02794

(30) Foreign Application Priority Data
Jun. 20, 2001 (GB) 0115103.4

(51) Int. Cl. A01N 1/02

(52) U.S. Cl. 435/2

(57) ABSTRACT

A multi-chamber module (10) for preparing sperm for assisted reproductive techniques comprises a first chamber (40) for holding a fluid medium, a second chamber (52) for receiving semen, and a third, harvesting chamber (50) into which the fluid medium flows from the first chamber (40) and from which that fluid medium passes into the second chamber (52), thereby to permit sperm to move against the fluid flow and pass from the second chamber (52) into the third chamber (50) from which they are harvested. A flow-restricting barrier composed of a stack of ribbed plates (44) defining radial passages therebetween is positioned between the second chamber (52) and the third chamber (50).

The present invention relates generally to infertility, and more particularly to apparatus for and methods of preparing sperm for assisted reproductive technology, including IUI (intra-uterine insemination), IVF (in vitro fertilization), GIFT (gamete intra-fallopian transfer) and ICSI (intra-cytoplasmic sperm insertion).

### BACKGROUND OF THE INVENTION

To increase the chances of fertilization, several kinds of treatment including IUI, IVF, GIFT and ICSI are performed with prepared sperm composed of viable, motile sperm, free of seminal plasma and debris. A variety of methods have been developed to separate motile sperm from semen. The most commonly used sperm isolation techniques, including “Swim up” and “Percol”, that involve washing and centrifugation, may result in some damage to the sperm (J. Kerlin and W. Byrd “Human Reprod.” 1991; 6: pages 1241-1246; R. J. Aitken and J. S. Clarkson: “J. Reprod. Fertil.” 1987; 81: pages 459-469.

More traditional methods for the preparation of sperm may lead to iatrogenic damage to sperm (D. Mortimer “Human Reprod.” 1991; 6: pages 173-176).

Aitken and Clarkson have shown that centrifugal force generates the production of reactive oxygen species that may damage sperm and impair their fertility potential. “Percol” has been used largely in the setting of laboratory research and its clinical use is associated with certain disadvantages. Some batches have been found to contain high levels of endotoxin, making them unsuitable for clinical use (C. Y. Andersen, and J. Grinsted: “J. Assisted Reprod. Gent.” 1997; 14: pages 624-628). In late 1996, “Percol” was withdrawn from clinical use as a sperm separation medium (Guneet Makkar et al. “Fertil. Steril.” 1999; 72: pages 796-802).

An ideal isolation technique would be rapid, inexpensive and isolate all motile sperm without damaging them.

It has been reported that when sperm are put into a fluid flow, the motile sperm rapidly align themselves and swim against the flow (F. Abed. “The new finding of a phenomenon in sperm motility: the spermatozoa swims against flow ” —from “In vitro fertilization and assisted reproduction”, edited by V. Gomel and P. C. K. Leung, Monduzzi Editore, 1997: pages 13-15). Non-motile and sluggish sperm, along with other cellular components, are washed downstream away from the motile sperm. Cilia have been shown to be present in endometrial cells of many mammals. Ciliary currents in both the fallopian tubes and the uterus move in the same direction and extend towards the external os. One may expect that this flow performs two functions. Firstly, this flow acts as a guide for sperm, leading sperm with the correct motility parameters towards the site of fertilization at the ampoule of the fallopian tubes. Secondly, this flow acts as a natural selection mechanism to optimize the quality of sperm able to reach the fertilization site.

### SUMMARY OF THE INVENTION

It is an object of the present invention to utilise the known phenomenon of sperm alignment against flow in order to be able to prepare sperm for assisted reproductive techniques and procedures.

In accordance with the present invention there is provided a multi-chamber module for preparing sperm for assisted reproductive techniques, comprising a first chamber for holding a fluid medium, a second chamber for receiving semen, and a third, harvesting chamber into which the fluid medium is arranged to flow from the first chamber and from which that fluid medium is arranged to pass into the second chamber, thereby to permit sperm to move against the fluid flow and pass from the second chamber into the third chamber from which they are harvested as sperm.

In a preferred embodiment, the second and third chambers are separated by a mechanical flow-restricting barrier through which fluid is arranged to flow from the third chamber to the second chamber and through which sperm are arranged to pass from the second chamber to the third chamber.

This barrier can comprise a stack of spaced plates or discs defining passageways therebetween.

The module also preferably includes control means for controlling the velocity of flow of the fluid from the first chamber to the third chamber.

In a preferred embodiment, the second and third chambers are located within a cup-shaped container with the chambers separated by an annular barrier through which the fluid is arranged to flow.

Preferably, the module includes a waste chamber into which waste material can pass from the second chamber, for example via filter means.

Also in accordance with the present invention there is provided a method of preparing sperm for assisted reproductive techniques, comprising establishing within a multi-chamber module a flow of fluid medium from a first chamber to a second chamber via a third chamber, adding fluid medium to the first chamber, adding semen to the second chamber, and harvesting from the third chamber sperm which pass, against the fluid flow, from the second chamber to the third chamber.

Preferably, the flow of fluid medium from the first chamber to the second chamber is controlled so that a steady-state flow of fluid medium is arranged to pass from the third chamber to the second chamber.

Also in accordance with the present invention there is provided a method of sperm preparation which comprises establishing within a processing module a fluid flow against which sperm are able to travel to a harvesting zone within the module.

The apparatus and methods of the present invention have a number of advantages over conventional methods of preparing sperm. The present invention does not induce any damage to the sperm, because the procedure does not require any use of chemicals or centrifuges. The preparation process is rapid and simple. The process of sperm separation is under direct observation and can easily be controlled. The module can be used by physicians without the need for laboratory equipment. Also, the use of the module in accordance with the invention not only serves to separate sperm, but also washes the sperm, thus eliminating the need for any centrifuge process. The present invention can be used not only for the separation of motile from non-motile sperm but also can be used with motile, morphologically normal sperm, to provide sperm suitable for ICSI procedures.

### BRIEF DESCRIPTION OF THE DRAWING

A more detailed description of the present invention will now be given, with reference to the accompanying drawing, wherein like reference characters refer to like parts throughout the several views, and in which:

FIG. 1 is a partially cut-away sectional view of a preferred embodiment of harvesting module in accordance with the invention;

FIG. 2 is a view, on an enlarged scale, of part of one of the guide plates of the module of FIG. 1; and

FIG. 3 is a view, again on an enlarged scale, of the two bottom guide plates of the stack shown in FIG. 1.

### DESCRIPTION OF THE PREFERRED EMBODIMENT

Referring to the drawing, the multi-chamber module of the present invention is indicated generally at 10. The module is substantially cylindrical in shape, with an outer circumferential wall 12, a base 14 and a cap 16. It is preferably made of plastics material. Extending radially inwardly from the outer circumferential wall 12 is a horizontal dividing wall 18 which continues at its radially inner face as an upwardly extending vertical wall 20 which meets the underside of the cap 16. Vertically below the wall 20 is an outer circumferential wall 22 of a cup-shaped container indicated generally at 24. This container 24 has a base 26. The upper edge of the outer wall 22 of the container 24 is spaced from the bottom of the vertical wall 20 to define a circumferential slot therebetween. This slot is plugged by a membrane filter 28. The filter is preferably such as to permit the passage only of material below a figure within the range of 1.3 to 3.5 microns, preferably below 3 microns. The cup-shaped container 24 is supported within the module, for example on a support member 30 which is set on the base 14 of the module. The interior of the support member 30 connects with a first port 32 and a second port 34 in the exterior wall 12 of the module.

Two holes 36 and 38 are formed through the base 26 of the container 24, adjacent to its centre. Hole 36 communicates with outlet port 34 via a valve (not shown). Hole 38 communicates with outlet port 32 via another valve (not shown). The valve associated with outlet port 32 is also connected to the chamber 40 which is defined by the walls 12, 18 and 20 and by the cap 16. This chamber 40 is hereinafter referred to as the medium chamber, i.e. a chamber which is arranged to hold a fluid medium.

The chamber 42 which is located below the medium chamber 40 and which extends below the base of the container 24 is hereinafter referred to as the waste chamber. A vent hole (not shown) is provided through the upper part of the outer wall 12 of the waste chamber.

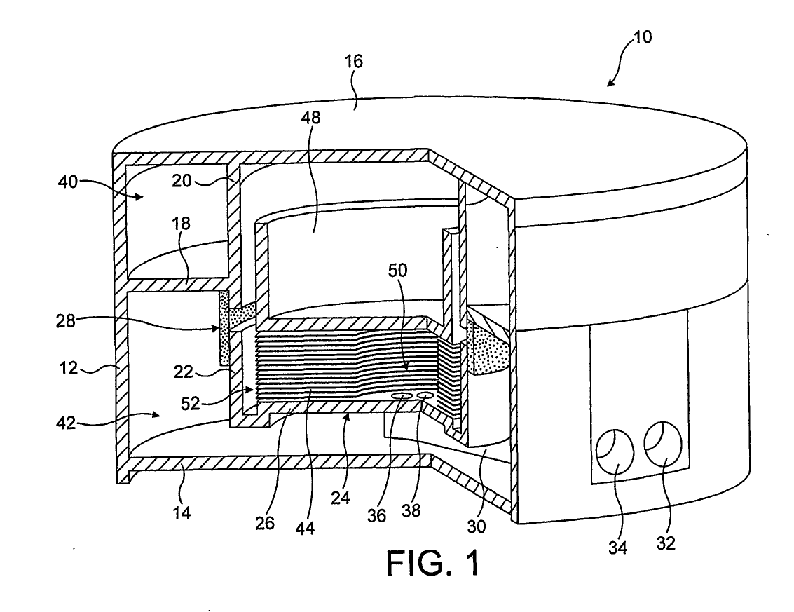

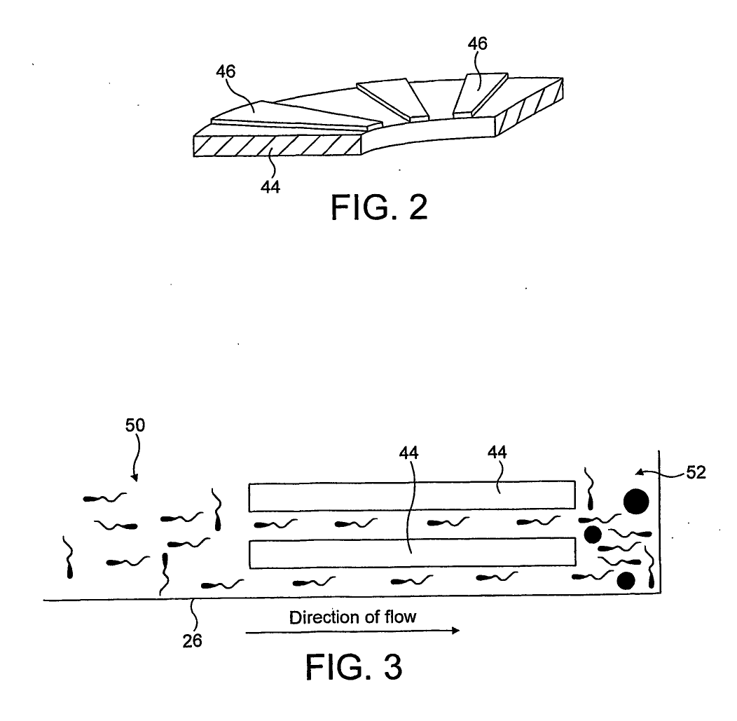

Within the cup-shaped container 24 is positioned a stack of annular plates or discs 44, a portion of one of which is shown in more detail in FIG. 2. These plates 44 are each annular in shape and are spaced from one another by the provision of a plurality of upstanding ribs 46 on the upper surface of each plate. As shown in FIG. 2, these ribs 46 are of constant thickness and are sector-shaped, extending from the inner radial wall to the outer radial wall of each plate 44. In a preferred embodiment, twenty of these sector-shaped ribs 46 are provided, equispaced around each plate. When the plates 44 are stacked one upon another, this leaves radial passages through the plates, between the ribs, with each passage having a depth of, for example, 30 to 50 microns. In a preferred embodiment, twenty plates 44 are stacked together. Above the stacked plates 44 is provided a cup-shaped receptacle 48. The plates 44 rest on the base 26 of the container 24 which, as can be seen from FIG. 1, is stepped around the perimeter. The location of the plates in this way leaves a central cylindrical chamber 50 above the holes 36 and 38, hereinafter referred to as the harvesting chamber, and an outer annular chamber 52, outwardly of the plates 44, hereinafter referred to the seminal chamber.

As mentioned above, the medium chamber 40 is in communication with the harvesting chamber 50 via the hole 38. The passageway between the medium chamber 40 and the harvesting chamber 50 is substantially L-shaped, with the valve associated with outlet port 32 being located approximately at the right-angle in the passageway. In the horizontal portion of the passageway there is located a plastics material rod (not shown) which has a longitudinally extending groove in its peripheral surface, along which the fluid medium from the chamber 40 can pass to the hole 38 and thus into the harvesting chamber 50. The groove in the rod serves to control the velocity of the fluid flow from chamber 40 to chamber 50.

The method of using the module of the present invention will now be described. A 5 ml syringe is first connected to the valve associated with port 32. The syringe is filled with a fluid medium. The valve associated with port 34 is opened and the module is inverted. Then, approximately 1.5 ml of the medium is injected into the harvesting chamber 50 via hole 38. This continues to ensure that there is no air remaining in the harvesting chamber. When the harvesting chamber has been filled with the fluid medium, the valve associated with port 34 is closed and the module is inverted again so that it is then as shown in the drawing. The syringe is then filled with air and is connected to the valve associated with port 32. Next, the cap 16 of the module is opened and the medium chamber 40 is filled with fluid medium. As a result of the gravitational forces, the medium in this chamber 40 flows through the passageway which links that chamber with the harvesting chamber 50, the fluid being regulated by the grooved rod housed within the support member 30.

Then, using a pipette, a small amount of semen is spread around the seminal chamber 52, i.e. outside the stack of plates 44. Then, the whole module is placed within a CO2 incubator. During the incubation period, motile sperm move against the flow of fluid, as shown most clearly in FIG. 3, by capillary flow from the seminal chamber 52 to the harvesting chamber 50. Because the medium chamber 40 is filled with the fluid medium before the sperm is added to the seminal chamber 52, there is already a flow of fluid between and through the plates 44 from the harvesting chamber 50 towards the seminal chamber 52. Because of the nature of the motile sperm, they are able to pass from the seminal chamber into the harvesting chamber, whereas sluggish and non-motile sperm cannot tolerate the flow of fluid and do not reach the harvesting chamber.

The seminal chamber 52 will gradually fill with fluid. Because of the presence of the membrane filter 28, only seminal plasma and other debris can pass through the filter from the seminal chamber 52 into the waste chamber 42.

Following the termination of the incubation period, which normally takes about 30 minutes, the cap 16 of the module is closed completely, the valve associated with port 34 is opened, and air is injected by syringe through port 32 and the associated valve and thus into the harvesting chamber 50. The pressure of this air causes the fluid medium within the harvesting chamber, and the motile sperm within it, to pass out through port 34 and into a sterile tube.

In the use of this module, normal sperm will be able to move against the fluid flow and pass the barrier which is provided by the ribbed plates. This mechanism serves to select the most qualified sperm and only permits the sperm that are capable of moving faster than the flow of fluid to reach the harvesting chamber. In this way, the motile sperm are separated from the seminal plasma, non-motile and sluggish sperm, other cellular components and bacteria.

It should be noted that the module of the present invention -can also be used for the separation from semen of motile, morphologically normal sperm, as is required for ICSI procedures.

1. A multi-chamber module for preparing sperm for assisted reproductive techniques, comprising a first chamber for holding a fluid medium, a second chamber for receiving semen, and a third, harvesting chamber into which the fluid medium is arranged to flow from the first chamber and from which that fluid medium is arranged to pass into the second chamber, thereto to permit sperm to move against the fluid flow and pass from the second chamber into the third chamber from which they are harvested as sperm.

2. A module according to claim 1, further comprising a mechanical flow-restricting barrier between the second and third chambers.

3. A module according to claim 2, wherein the mechanical barrier comprises a stack of spaced plates defining at least one passageway there between.

4. A module according to claim 3, wherein the spaced plates are substantially annular.

5. A module according to claim 3, wherein the plates are provided with spacer ribs.

6. A module according to claim 5, wherein the ribs are sector-shaped.

7. A module according to claim 5, wherein each plate is provided with 20 ribs.

8. A module according to 3, wherein the stack comprises 20 plates.

9. A module according to 3, wherein the or each passageway has a depth of about 30 to about 50 microns.

10. A module according to claim 1, further comprising control means for controlling the velocity of flow of the fluid medium from the first chamber to the third chamber.

11. A module according to claim 10, wherein the control means comprises a rod having a longitudinally extending groove in its peripheral surface, the rod being located within a fluid medium passageway.

12. A module according to claim 10, wherein the control means is capable of controlling the flow of the fluid medium to provide a steady state flow of fluid medium from the third chamber to the second chamber.

13. A module according to claim 1, wherein the second and third chambers are located within a cup-shaped container and are separated by an annular flow-restricting barrier.

14. A module according to claim 1, further comprising a waste chamber into which waste material can pass from the second chamber.

15. A module according to claim 14, further comprising filter means located between the second chamber and the waste chamber.

16. A module according to claim 15, wherein the filter means permits the passage only of material smaller than 1.3 to 3.5 microns.

17. A module according to claim 15, wherein the filter means permits the passage only of material smaller than 3 microns.

18. A module according to claim 1, which is of substantially cylindrical shape.

19. A module according to claim 1, made of plastics material.

20. A module according to claim 1, made of glass.

21. A method for harvesting sperm comprising the steps of: providing a multi-chamber module having a first chamber for holding a fluid medium, a second chamber for receiving semen, and a third chamber for harvesting sperm;
providing a fluid medium in the first chamber;
establishing a flow of fluid medium from the first chamber to the second chamber via the third chamber;
providing semen in the second chamber;
incubating the multi-chamber module; and
harvesting sperm from the third chamber.

22. A method of preparing sperm for assisted reproductive techniques, comprising establishing within a multi-chamber module a flow of fluid medium from a first chamber to a second chamber via a third chamber, adding fluid medium to the first chamber, adding semen to the second chamber, and harvesting from the third chamber sperm which pass, against the fluid flow, from the second chamber to the third chamber.

23. A method according to claim 22, in which the flow of fluid medium from the first chamber to the second chamber is controlled so that a steady-state flow of fluid medium is arranged to pass from the third chamber to the second chamber.

24. A method of sperm preparation which comprises establishing within a processing module a fluid flow against which sperm are able to travel to a harvesting zone within the module.
